(19) United States
(12) Patent Application Publication
(10) Pub. No.: US 2025/0136477 A1
(43) Pub. Date: May 1, 2025

(54) Waste Water Treatment to Remove Fat, Oil, and Grease

(71) Applicant: Aquarius Limited, Brierley Hill West Midlands (GB)

(72) Inventors: Nicholas Rogers, Brierley Hill West Midlands (GB); Luke Connolly, Brierley Hill West Midlands (GB)

(21) Appl. No.: 18/834,193

(22) PCT Filed: Jan. 31, 2023
(86) PCT No.: PCT/GB2023/050216

§ 371 Date: Jul. 29, 2024

(30) Foreign Application Priority Data
Jan. 31, 2022 (GB) 2201227.2

(51) Int. Cl. C02F 1/40; B01D 17/02; C02F 101/32; C02F 103/32

(52) U.S. Cl. CPC C02F 1/40; B01D 17/0211; B01D 17/0214; C02F 2101/32; C02F 2103/32; C02F 2201/004; C02F 2201/005; C02F 2201/008

(57) ABSTRACT

An apparatus suitable for treating waste water to remove scum contaminants such as fat, oil, and grease is provided. The apparatus comprises a main tank and a waste collection tank that is removably coupled to the main tank. The main tank comprises an inlet for receiving the waste water from a waste water source. The inlet receives waste water. The waste water typically comprises contaminants, such as particulate contaminants and scum contaminants such as fat, oil and grease. The main tank comprises a water collection chamber, for collecting the waste water from the inlet. The main tank further comprises a grease removal unit for treating the waste water by separating the scum contaminants from the waste water. The waste collection tank is in fluid communication with the grease removal unit for collecting the contaminants and is removably coupled to the main tank.

### CROSS-REFERENCE TO RELATED APPLICATIONS

The present application is a U.S. National Stage Application under 35 U.S.C. § 371 of International Application No. PCT/GB2023/050216 filed Jan. 31, 2023, which claims priority to GB Application No. 2201227.2 filed on Jan. 31, 2022, all of which are incorporated herein by reference in their entirety for all purposes.

### TECHNICAL FIELD

The present invention relates to the field of fluid treatment, and in particular to an apparatus and method for treating waste water to remove scum contaminants.

### BACKGROUND

One of the challenges facing water companies is the maintenance of sewage systems, with accumulations of oil, grease and fat combining with non-biodegradable items to form “fatbergs” that can block sewers. Kitchens, particularly those of service restaurants have a (sometimes legal) responsibility to ensure that fats, oil, grease and the like do not end up entering into drains or sewers via wastewater.

An existing solution is shown in GB2503421. This apparatus is used to remove grease and other debris from waste water and is placed between the waste water outlet and the drainage system. This system works to avoid blockages by slowing the flow of wastewater leaving a drain, and diverting fats, oil and grease into a trap that can be emptied and collected.

An alternative solution is shown in GB2562127. In this disclosure a waste interceptor is described that uses a drain and strainer basket for collecting waste water and solid waste. The basket can be opened to remove solid waste, but does not disclose a way to empty other waste that is not caught by the basket.

The systems described above and in the art typically comprise either a passive solution, which acts to slow the flow of wastewater from a drain, cooling said wastewater such that solids, scum contaminants (fats, oil, grease) and water separate and can be removed by siphoning or the like, or are automatic units that act to remove the scum contaminants actively by skimming.

It is an aim of the present invention to at least ameliorate some of the above identified problems associated with the prior art.

### SUMMARY OF INVENTION

According to a first aspect of the present invention there is provided an apparatus suitable for treating waste water to remove scum contaminants such as fat, oil, and grease, said apparatus comprising: a main tank and a waste collection tank that is removably coupled to the main tank. The main tank comprises an inlet for receiving the waste water from a waste water source. The inlet is typically connected to the waste drain of a restaurant water drain or the like and receives waste water. The waste water typically comprises contaminants, such as particulate contaminants and scum contaminants such as fat, oil and grease. The main tank comprises a water collection chamber, for collecting the waste water from the inlet. The main tank further comprises a grease removal unit for treating the waste water by separating the scum contaminants from the waste water. The waste collection tank is in fluid communication with the grease removal unit for collecting the contaminants and is removably coupled to the main tank.

By providing a separate waste collection tank that is removably coupled to a main water collection chamber the contaminants removed from the grease removal unit into the waste collection tank can be easily emptied or cleaned or replaced. This allows for less down-time for the apparatus given that a single unit can be easily emptied, cleaned or replaced rather than traditional systems which require the whole system to be disconnected from the waste water supply to clean the apparatus and remove the collected contaminants.

In some embodiments the grease removal unit comprises a valve, said valve in fluid communication with the water collection chamber and with the waste collection tank. The use of a valve allows the contaminants in the waste water within the water collection chamber to be controllably removed by the valve and collected into the waste collection tank. Additionally, the valve acts to prevent the contaminants within the waste collection tank from re-contaminating the waste water.

Preferably the valve is configured to open to selectively collect the scum contaminants from the surface of the waste water within the water collection chamber and to close to isolate the water collection surface from the valve. In this manner, the valve may be configured to open to drain the scum contaminants into the waste collection tank and to close to isolate the waste collection tank from the grease removal unit. In an embodiment the valve may be a rocker valve such that the valve is in fluid communication with either the water collection chamber or with the waste collection tank at any one time. This acts to prevent the risk of contaminants from re-entering the water collection chamber and allows for the controlled removal of the contaminants from the waste water of the water collection chamber into the waste collection tank by controlling operation of the valve. This can act to ensure that the valve remains closed if the waste collection tank is full or currently removed from the system for cleaning or replacement or the like.

The valve and/or the grease removal unit may comprise a runoff surface, said surface angled such that fluid flows from the water collection chamber to the waste collection tank. Accordingly, as the valve opens to the water collection chamber to collect scum contaminants from the surface of the waste water, the contaminants are syphoned from the waste water and run onto the runoff surface towards the waste collection tank due to the angle of the runoff surface.

In some embodiments the valve is or comprises a ball valve between the grease removal unit and the water collection chamber. The ball valve may be an automatic ball valve. The use of a ball valve allows for the controlled opening of the valve to allow contaminants to pass from the waste water of the water collection tank and into the waste collection unit. It can be appreciated that the ball valve may form part of the or a rocker valve, or there may be additional chambers or valves between the rocker valve or runoff surface and the ball valve.

The valve and/or the grease removal unit may further comprise a secondary valve between the ball valve and the runoff surface.

The grease removal unit may further comprise an isolation valve, such as a plunger valve between the runoff surface and the waste collection tank. This secondary valve acts to prevent backflow of material skimmed off the surface back into the main tank.

The isolation valve can include a biasing means biasing the isolation valve closed to fluidly isolate the waste collection tank from the runoff surface. Accordingly the isolation valve is generally held in the open position when the rocker valve is in fluid communication with the waste collection tank.

In an embodiment, the isolation valve engages with the waste collection tank to fluidly communicate the waste collection tank to the grease removal unit when the waste collection tank is coupled to the main tank.

In a further embodiment, the waste collection tank may comprise an actuator. The actuator may be an electrical switch or a mechanical actuator, said actuator configured to seal the waste collection tank when the tank is removed from the apparatus. The actuator may comprise a mechanical lock for locking the waste collection tank to the apparatus.

Additionally or alternatively, the apparatus may comprise an actuator configured to open the isolation valve when the waste collection tank is coupled to the main tank. This actuator may be a mechanical actuator configured to displace the isolation valve to allow fluid flow from the grease removal unit to the waste collection tank. The actuator may be coupled to the grease removal unit or to the waste collection tank.

In some embodiments the main tank may further comprise an inlet chamber in fluid communication with the inlet, said inlet chamber comprising an angled surface to induce vortex currents in the waste water to slow movement of the waste water. The use of an inlet chamber can allow for larger particulates to be removed from the waste water as it is slowed down entering the main tank.

The main tank typically further comprises an outlet for removing treated waste water from the main tank. Accordingly, the grease removal unit is typically positioned above the water collection chamber, and is fluidly isolated from the inlet and from the outlet. The grease removal unit therefore acts as a baffle between the top of the main tank and the water collection chamber.

The grease removal unit may be removably coupled to the main tank to prevent the grease removal unit from floating when waste water enters the water collection chamber. The grease removal unit may be removably coupled with an attachment mechanism, said attachment mechanism comprising one or more protrusions on the grease removal unit configured to interact with one or more corresponding apertures in the wall(s) of the main tank. The one or more protrusions may comprise an undercut to engage with the one or more corresponding apertures. Further, the removable coupling allows the apparatus to instead be used as a passive grease trap.

Typically, the apparatus as described allows waste water that enters the main tank by the inlet to treated using the grease removal unit, with treated waste water leaving the apparatus via the outlet. Accordingly, it can be appreciated that the inlet may be connected to a waste water outlet of a restaurant or the like, the waste water from the restaurant is then treated by the apparatus, with treated waste water exiting the apparatus via the outlet which can be connected to the water drainage or sewage network.

Accordingly, as noted above, the apparatus may further comprise a waste food collecting unit coupled to the inlet, said waste food collecting unit configured to remove debris from the waste water prior to entry into the inlet.

In further embodiments, the waste collection tank may be coupled to the main tank by a retaining knob, said knob engaging through the waste collection tank to a housing of the main tank. The retaining knob typically comprises a bayonet locking mechanism to retain the waste collection tank. The waste collection tank may comprise an indicator to show the current fill level of waste within the tank. The indicator may comprise an alert to alert a user that the waste collection tank should be replaced or emptied. The indicator may show a level of contaminants collected by the waste collection tank to allow determination of when to replace or empty the tank. The indicator may comprise a timing unit that alerts when an expected time has elapsed by when the waste collection tank should be replaced or emptied.

The apparatus may further comprise a lid configured to cover the main tank. A gasket may be provided between the lid and the main tank, such that the seal is not airtight. An airtight seal would reduce the drainage of the contaminants to the waste collection tank, and is ideally avoided.

The lid may comprise a plurality of lug latches to secure the lid to the main tank, such that the lid has no hinge point.

The main tank may comprise two inlets and have a rotational symmetry of 2, such that it can be mounted reversibly. This may be important in installations where space is limited and accordingly the inlets may be arranged to best suit the installation location. Similarly, the grease removal unit may comprise a pair of valves, wherein the second valve is disposed opposite the first valve such that the grease removal unit has a rotational symmetry of 2 and can be mounted reversibly within the main tank.

The other components of the apparatus may be paired similarly, such that the apparatus has a rotational symmetry of 2, allowing the apparatus to be mounted in two orientations. The food waste trap may be configured to be mounted to either side of the main tank, with the corresponding inlets. As noted, advantageously, this rotational symmetry, and option to mount the food waste trap either side of the main tank, provides greater flexibility for a user in mounting and positioning the apparatus.

The apparatus may further comprise a base configured to support the main tank and one or more waste collection tanks. Optionally or preferably, the base may comprise wheels to aid transport of the apparatus.

The apparatus may further comprise a drain tap configured to engage with the body of the main tank. The drain tap may be configured to filter off the scum from the top of the water collection chamber when the grease removal unit is not in use, or as an additional method of removing contaminants.

In some embodiments the waste collection tank may be configured to supply electrical power to the grease removal unit. The electrical power may be provided to actuate the valve. The electrical power may be at least partially provided by a battery associated with the apparatus. The battery may be removably coupled to the waste collection tank and/or other components of the apparatus. The battery may be rechargeable.

In some embodiments the apparatus may further comprise heating elements to maintain the contents of the water collection chamber and/or the waste collection tank at a predefined temperature, typically above the solidification point of the scum constituents. Example temperatures are 20 degrees Celsius, or at a temperature above 10 degrees Celsius.

In a second aspect of the present invention there is provided a method of emptying a fat, oil and grease removal apparatus as defined in any part of the first aspect, said method comprising the steps of: decoupling the waste collection chamber from the main tank; and coupling an empty waste collection chamber to the main tank.

It can be appreciated that the embodiments of the first aspect may be combined with the assembly described in the additional aspects described above and in relation to the figures below.

### BRIEF DESCRIPTION OF THE DRAWINGS

Embodiments of the invention will now be described, by way of example only, with reference to the accompanying drawings, in which:

FIG. 1 shows an apparatus for treating waste water to remove scum contaminants in accordance with the present invention;

FIG. 2 shows the internal structure within the housing of the apparatus of FIG. 1:

FIG. 3 shows an isolated view of a grease removal unit located within the apparatus as shown in FIG. 2:

FIG. 4 shows a valve arrangement of the grease removal unit of FIG. 3:

FIG. 5 shows a partial sectional view of the valve arrangement of FIG. 4:

FIG. 6 shows a close up sectional view of one part of the valve arrangement shown in FIG. 5:

FIG. 7 shows a waste collection tank in which the scum contaminants are collected:

FIG. 8 shows an alternative apparatus for treating waste water to remove scum contaminants in accordance with the present invention;

FIG. 9 shows the internal structure of the waste food trap of the apparatus of FIG. 8:

FIG. 10 shows the grease removal unit of the apparatus of FIG. 8:

FIGS. 11A and 11B show the valve arrangement of the grease removal unit of FIG. 10; and

FIG. 12 shows a waste collection tank in which the scum contaminants are collected.

### DETAILED DESCRIPTION

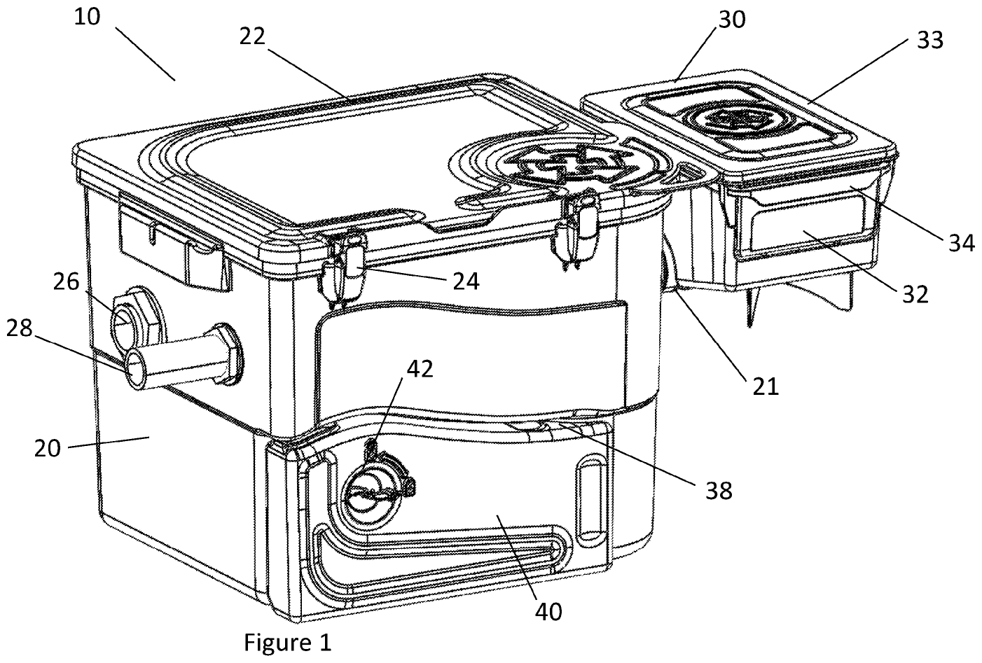

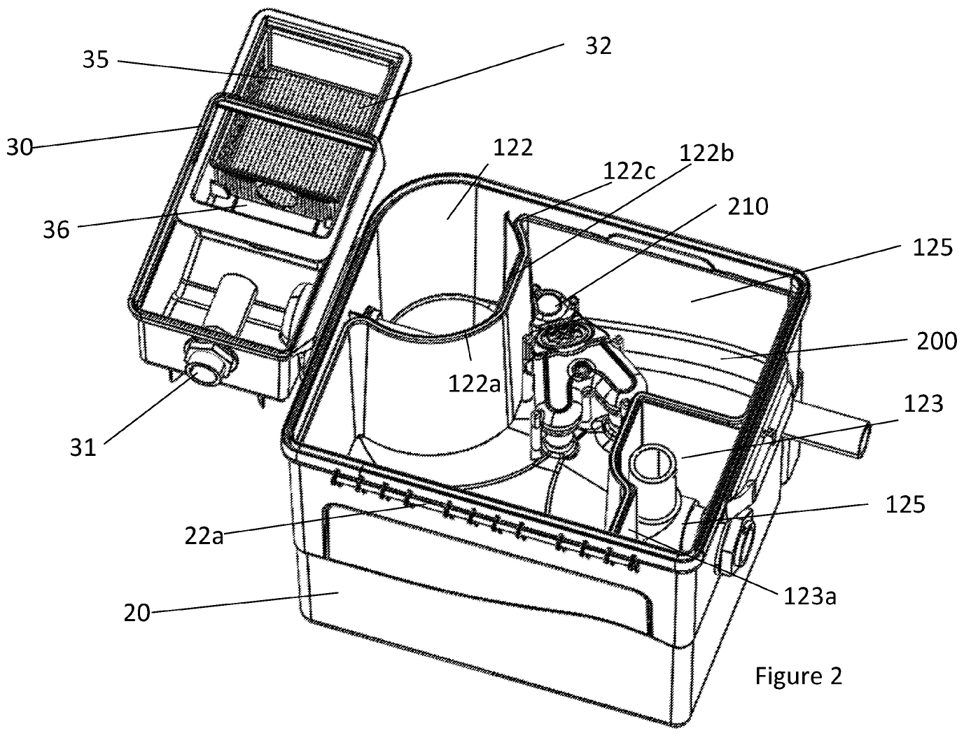

FIGS. 1 and 2 show an apparatus 10 suitable for treating waste water to remove scum contaminants such as fat, oil, and grease. The apparatus 10 broadly comprises a main tank 20, a waste food collecting unit 30 fluidly connected to the main tank, and a waste collection tank 40 that is removably coupled to the main tank.

The main tank 20 is typically broadly square in shape and provides a housing. The main tank is typically made from plastic or the like, and comprises an inlet 21 for receiving waste water from the waste food collecting unit 30, a lid 22 allowing access to the interior of the main tank and secured with one or more clasps 24 or fasteners to the exterior of the tank 20, and an outlet 26. The main tank 20 is typically thermally insulated, either by providing an insulating surround of foamed polypropylene, polystyrene or the like, or by a cavity wall style design. This ensures that separated fat, oil and grease scum contaminants remain liquid and are easier to remove from the waste water. It can be appreciated that the system 10 may be heated to achieve a similar effect, with an electrically powered thermal blanket or surround ensuring that the waste water within the main tank is kept above the freezing or solidifying temperature of the scum contaminants. An external power supply can be used to activate the thermal blanket. Additionally, or alternatively, one or more batteries may provide the power supply for the thermal blanket element. Additionally or alternatively, electrical thermal elements (akin to a kettle) may be provided within the main tank to provide a heating effect. These may be at least partially battery powered.

The inlet 21 is typically a waste water inlet for receiving waste water having scum contaminants. The inlet is typically connected to the food collecting unit 30, which acts to remove larger particulates from the waste water prior to passing the waste water to the main tank 20. It can be appreciated that the waste food collecting unit 30 may be bypassed or omitted such that waste water directly enters the main tank via the inlet 21.

The lid 22 allows for easy servicing of the apparatus 10 by providing access to the housing to check the internal components, fill-level, etc. As with the main tank 20, the lid 22 is also typically thermally insulated in a similar manner. Clasps 24 are shown for holding the lid closed, but any suitable closure can be provided.

The outlet 26 is provided on an external surface of the tank. The outlet allows for treated waste water to leave the unit 10. Multiple outlets may be provided as needed. The outlet is connected to the sewage or waste water system. It may be directly connected to the sewage system, or it may be coupled using an additional pipe or conduit or the like. An overflow 28 may also be provided in the event that the outlet is blocked or overwhelmed.

Coupled to the main tank 20 via a fluid coupling 21 is a waste food collecting unit 30. This unit 30 comprises an inlet 31 for receiving waste water from a waste water source, such as the drain of a restaurant or other commercial business generating waste water. The inlet typically receives waste water having contaminants, such as particulate contaminants and scum contaminants such as fat, oil and grease. The waste food collecting unit 30 comprises a basket 32 configured to be slidably engaged with the unit 30, the basket 32 comprising a mesh 35 over which water from the inlet 31 flows to sieve larger particulates. A collecting unit lid 33 is provided to allow easy access for cleaning.

In use, the waste food collecting unit 30 receives waste water, which passes over the mesh 35 to sift non-scum waste contaminants. These are collected in the basket 32, which can be removed by slidingly retracting the basket from the body of the collecting unit. After passing across the mesh, the sieved waste water collects within the unit 30 until the water level reaches the water inlet height where the waste water enters the main tank 20.

As shown in FIG. 2, the main tank 20 further comprises a water collection chamber 122, for collecting the waste water from the inlet 21. The water collection chamber 122 extends across the base of the main tank 20. The main tank additionally comprises a grease removal unit 200 for treating the waste water by separating the scum contaminants from the waste water and into the waste collection tank 40.

The waste collection tank 40 is provided with the main tank 20. As shown in FIG. 1, the collection tank 40 lies substantially flush against a lower portion of the exterior of the main tank 20. The collection tank 40 lies against a corresponding indented section of the lower portion.

The waste collection tank 40 is fluidly coupled to the main tank 20 via a fluid connection 38 that is also in fluid communication with the grease removal unit 200 and is secured to the main tank via a retaining knob 42. The retaining knob 42 may be a bayonet style connection that acts to secure the tanks together and to release the waste collection tank 40, although it can be appreciated that any other suitable retaining means may be used.

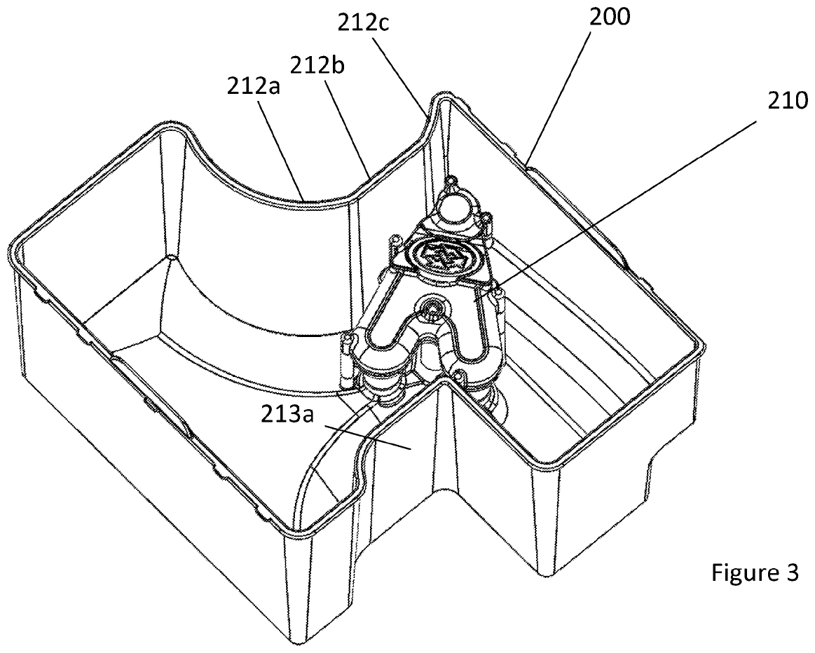

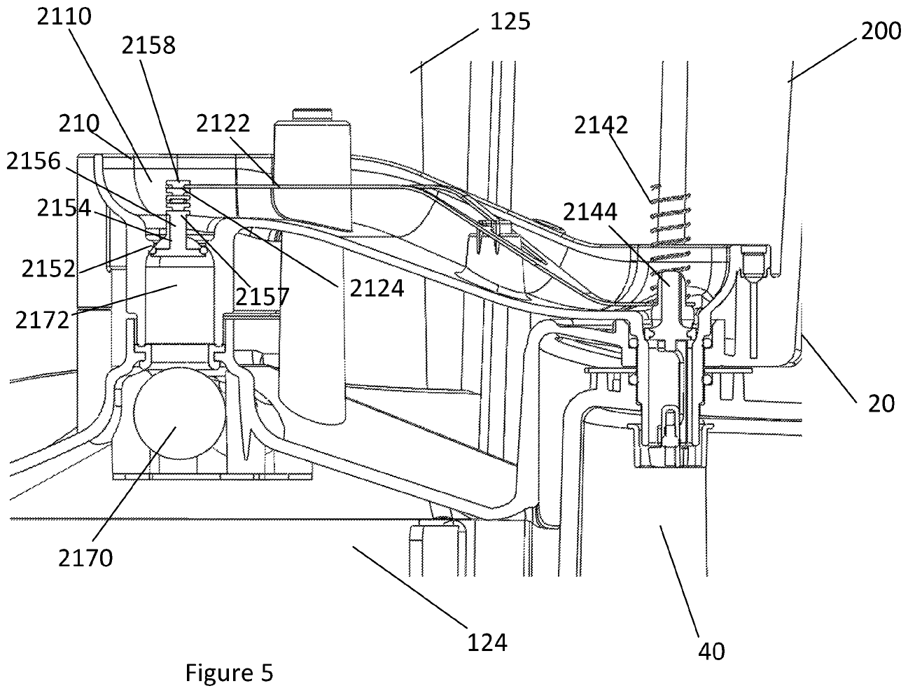

The grease removal unit 200 is shown in FIGS. 2 to 6. The grease removal unit 200 is provided in the interior of the housing of the main tank and acts (with or without the use of additional housing walls) to separate the interior into separate chambers. In particular, the interior is divided into a first chamber 122, a second chamber 123, a lower chamber 124 and an upper chamber 125. In other words, the first chamber 122 may be formed by interior walls 122a, 122b, 122c and the outer wall of the main tank housing, or may be formed by the outer wall of the main tank housing and the exterior walls 212a, 212b, 212c of the grease removal unit.

The first chamber 122 acts to receive water from the inlet 21, which fills the first chamber. The first chamber 122 is often described in the art as a vortex inlet chamber and is designed to slow the flow of water entering the main tank 20. This may be achieved in a number of ways. Typically, the inlet or first chamber 122 is designed to induce circular or vortex flows in the incident waste water flow by impacting the incident flow against a curved surface 122a. The curvature of the surface 122a diverts the incident waste water flow, deflecting the flow against walls 212b and 212c. This acts to induce vortex currents that sap the flow, retarding it. Additionally, baffles (not shown) between the first chamber 122 and the lower chamber 124 again act to divert and direct flow from the first chamber 122 into the lower chamber 124.

The second chamber 123 is fluidly coupled to the lower chamber 124 and may have walls or the like providing separation. The second chamber 123 may be formed by provision of walls 123a and the interior wall of the main tank, or may be provided as a separate chamber placed within the main tank, or may be formed by the walls of the main tank and the external walls 213a of the grease removal unit 200. As shown, the second chamber 123 has a fluid coupling 125 connecting the chamber to the outlet 26. The fluid coupling 125 is substantially t-shaped and receives and removes waste water when the level of water in the second chamber reaches a level higher than the outlet 26. As described previously, the overflow 28 is located higher than the outlet 26 such that excess water can leave the main tank in case of blockage or overwhelming of the outlet 26.

The grease removal unit 200 is placed within the housing such that it sits below the level of the outlet. The grease removal unit comprises a moulded plastic or metal inlet and is configured to sit against the walls of the main tank 20 and to either form the first and second chambers or to abut against walls that form said chambers. The grease removal unit may sit on inset surfaces within the main tank, or may be provided with feet to stand against a base of the main tank.

The grease removal unit 200 comprises a valve unit 210 that is configured to mounted within the grease removal unit and opens to draw scum from the surface of the waste water within the main tank. The valve unit 210 is configured to direct the scum into the waste collection tank 40. Although shown with a single valve unit, it can be appreciated that two or more valve units 210 may be provided. In this case, the multiple valve units may each have a separate waste collection tank (which may be separate chambers of a common waste collection tank), or may direct the scum into the waste collection tank by diverting the scum into the waste collection tank along a channel fluidly connected to the outlets of each valve unit.

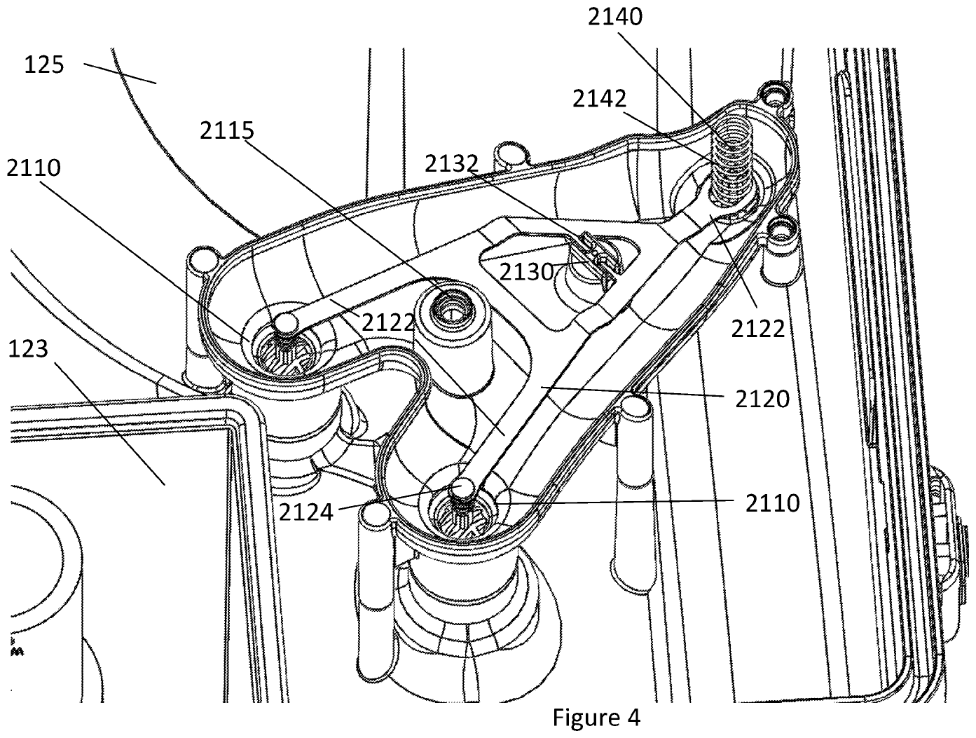

The valve unit 210 is shown in greater detail in FIGS. 4 to 6 and comprises two inlet valves 2110 that are configured to open to admit scum from the surface of the waste water in the main tank and onto a runoff surface 2115 of the valve unit 210. The runoff surface 2115 is angled such that fluid flows from the water collection chamber to the waste collection tank. Accordingly, as the valve of the grease removal unit opens to the water collection chamber to collect scum contaminants from the surface of the waste water, the contaminants are syphoned from the waste water and run onto the runoff surface towards the waste collection tank due to the angle of the runoff surface.

Although shown with two inlet valves, it can be appreciated that one valve, or more than two valves may be used. The inlet valves allow the scum contaminants in the waste water within the water collection chamber to be controllably removed by the valve and collected into the waste collection tank.

The inlet valves are actuated by a rocker mechanism 2120. One end of the rocker mechanism comprises arms 2122 that are coupled to the inlet valve 2110 using a split end 2124 that snap fits around a stem 2156 of the inlet valve 2110, abutting a flared end 2157 thereof. A cap or washer 2158 holds the arm in position.

In the example shown, the arms 2122 form a wishbone configuration. The other end 2122 of the rocker mechanism is configured to engage with a drainage or isolation valve 2140. The isolation valve 2140 include a spring 2142 that acts as a biasing means, biasing the isolation valve closed to fluidly isolate the waste collection tank 40 from the runoff surface 2115. The spring 2142 engages with a flared stem 2144 of the isolation valve 2140 using a lip engagement or the like. The end 2122 of the rocker mechanism also engages against the flared stem 2144.

The rocker mechanism 2120 engages with a fulcrum 2130 of the valve 2110 that is formed in raised surface of the run-off surface. In the example shown, a cross-bar 2132 engages with the fulcrum using a snap fit arrangement or the like, but is free to rotate relative to the fulcrum. The cross-bar 2132 and the arms 2122 form an A-frame for the rocker mechanism, with the arms of the A-frame connected to the inlet valves and the head of the A frame connected to the isolation valve as described above.

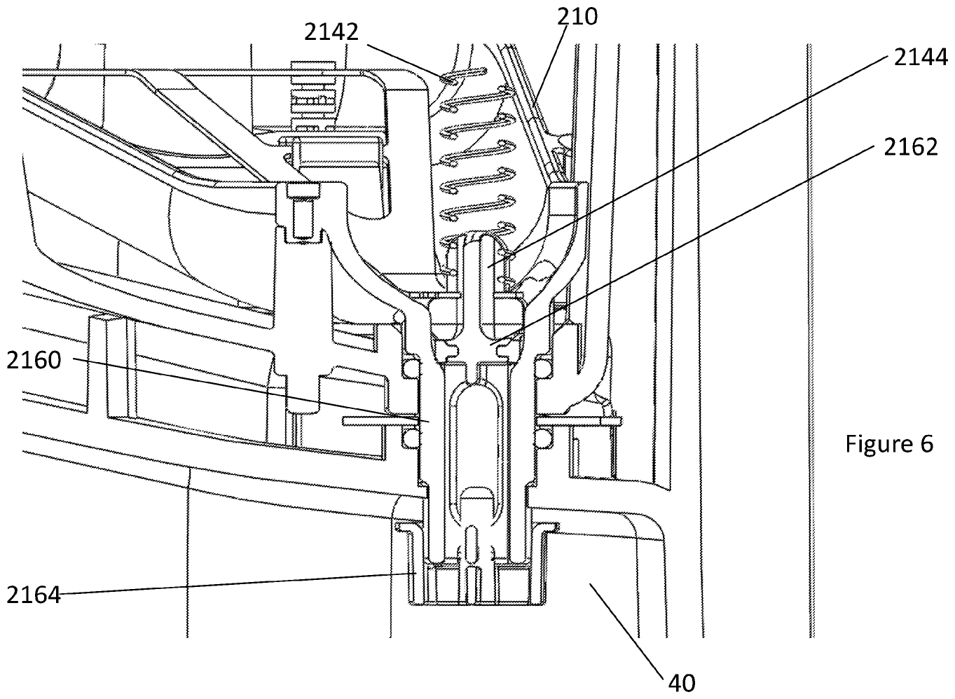

In use, the spring 2142 acts to bias the head 2122 of the rocker mechanism down. This in turn acts against the flared stem 2144 of the isolation valve 2140 and keeps the isolation valve closed. This is shown in FIG. 6, with the action of the spring 2142 against the stem 2144 pressing base 2162 of the stem against a side wall of isolation valve chamber 2160, sealing the valve.

The valve is opened by insertion of a water collection tank 40 into engagement with the main tank 20. The waste collection tank comprises a connector cap 2164 that acts as an actuator, engaging with the stem 2144 and opening the isolation valve. Accordingly, when the isolation valve engages with the waste collection tank, the waste collection tank and the grease removal unit are fluidly coupled and the isolation valve is generally held in the open position when the rocker valve is in fluid communication with the waste collection tank.

The inlet valves 2110 in the embodiment shown comprise a dual valve arrangement. In particular a ball valve 2170 is used to isolate and fluidly communicate the grease removal unit 210 from the water collection chamber 112 of the main tank 20 such that as the ball valve 2170 opens it allows scum contaminants (fats, grease and the like) to enter a chamber 2172 of the inlet valve 210. The ball valve may be an automatic ball valve such that the grease removal unit is isolated or coupled to the water collection chamber as needed. For example, the grease removal unit may be isolated when replacing the waste collection tank, or when the waste collection tank is full.

In addition to the ball valve, the inlet valve further comprises an umbrella valve 2154 that sits within a seat 2152 in a chamber of the isolation valve. The umbrella valve comprises a stem 2156 that is coupled to an arm 2122 of the rocker valve 2120 as described above. The umbrella valve is seated to open when the isolation valve is opened. This allows entry of scum contaminants from the chamber 2172 and into the grease removal unit when the water level of the water collection chamber 122 of the main tank is higher than the height of the umbrella valve.

In particular, as the isolation valve is opened the umbrella valve is directed down into the chamber 2172 due to the engagement of the stem 2156 and the arms 2122. The top of the A frame rocker valve mechanism connected to the isolation valve moves up, causing the arms of the A frame rocker valve mechanism to move down. This downward movement unseats the umbrella valve and brings the chamber 2172 into fluid engagement with the grease removal unit.

In some embodiments the valve comprises a ball valve between the grease removal unit and the water collection chamber. The ball valve may be an automatic ball valve. The use of a ball valve allows for the controlled opening of the valve to allow contaminants to pass from the waste water of the water collection tank and into the waste collection unit. It can be appreciated that the ball valve may form part of the or a rocker valve, or there may be additional chambers or valves between the rocker valve or runoff surface and the ball valve.

It can be appreciated that this dual valve arrangement acts to prevent backflow of material skimmed off the surface back into the main tank when the waste collection tank 40 is full.

In a further embodiment, the waste collection tank may comprise an actuator. The actuator may be an electrical switch or a mechanical actuator, said actuator configured to seal the waste collection tank when the tank is removed from the apparatus. The actuator may comprise a mechanical lock for locking the waste collection tank to the apparatus.

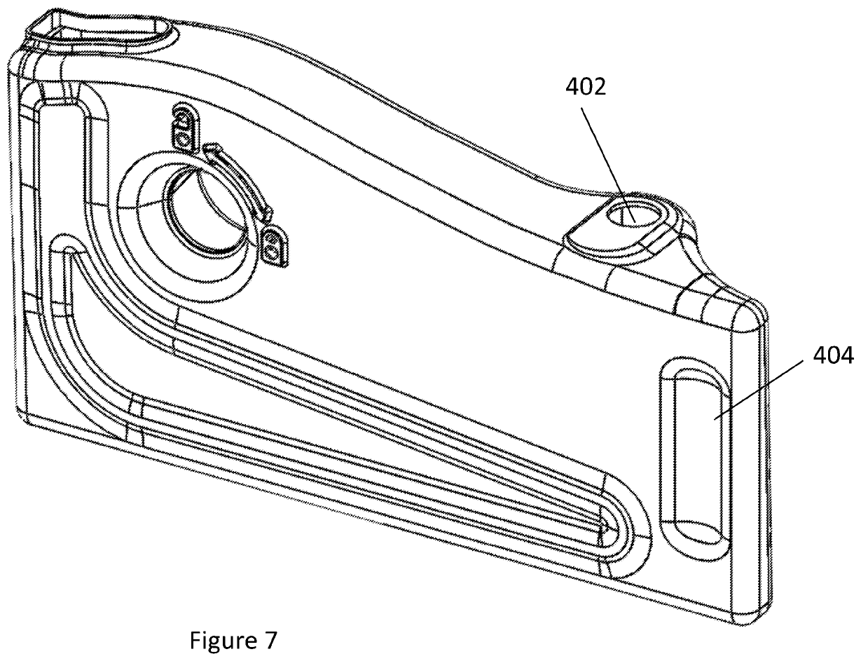

The waste collection tank 40 is shown in FIG. 7. As described above, the tank 40 is configured to engage with the main tank. This engagement in the embodiment shown is by a retaining knob 42, said knob engaging through the waste collection tank to a housing of the main tank as shown in FIG. 7. The retaining knob 42 typically comprises a bayonet locking mechanism to retain the waste collection tank 40.

The waste collection tank 40 comprises an inlet 402 for receiving the actuator 2164. The shape of the waste collection tank as shown allows for easy alignment of the inlet 402 with the isolation valve chamber 2160 to provide easy engagement with the actuator.

The waste collection tank comprises an indicator 404 to show the current fill level of waste contaminants within the tank. The indicator 404 shows a level of contaminants collected by the waste collection tank to allow determination of when to replace or empty the tank. The indicator includes a visual limit indicator, or a timing unit or the like that indicates when the waste collection tank should be replaced or emptied. The indicator acts as a visual alert to alert a user that the waste collection tank should be replaced or emptied.

In some embodiments the waste collection tank may be configured to supply electrical power to the grease removal unit. The electrical power may be at least partially provided by a battery associated with the apparatus. The battery may be removably coupled to the waste collection tank and/or other components of the apparatus. The battery may be rechargeable. The electrical power may be provided to actuate the rocker valve. This may involve movement of the actuator 2164 to open and close the isolation valve and accordingly the inlet valve 2110 of the grease removal unit 210. In this manner, the risk of the grease removal unit overfilling is minimised or eliminated. The electrical power may additionally or alternatively be used to supply electrical power to a thermal heating blanket or electrical thermal element for the main tank as described above. Further additionally or alternatively such thermal elements or blankets may also be provided for the waste collection tank to minimise risk of blockages forming within the tank. For a similar reason, the waste collection tank may be thermally insulated as described above, or may be encompassed in any thermal insulation solution for the main tank.

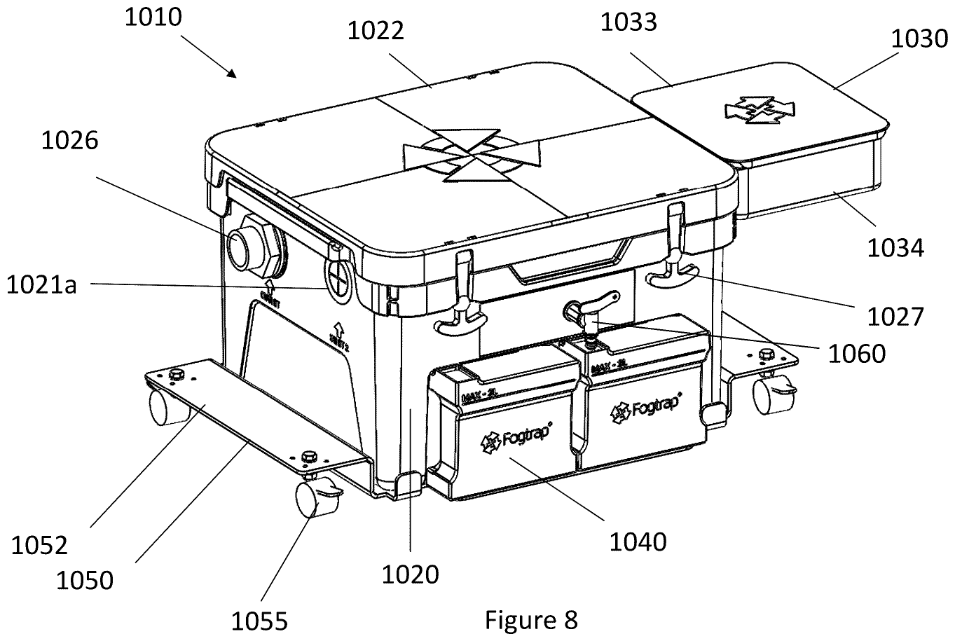

FIG. 8 shows an apparatus 1010 suitable for treating waste water to remove scum contaminants such as fat, oil, and grease. Similarly to the apparatus 10 of FIGS. 1 and 2, the apparatus 1010 broadly comprises a main tank 1020, a waste food collecting unit 1030 fluidly connected to the main tank 1020, and a waste collection tank 1040 that is removably coupled to the main tank 1040. It can be appreciated that, with the exception of mutually exclusive features, which are described in more detail below, the features described in relation to the first embodiment of FIGS. 1 to 7 may also be applied to apparatus 1010.

The main tank 1020 is broadly similar to that of main tank 20. It is typically broadly square in shape and provides a housing. The main tank is typically made from plastic or the like, and comprises an inlet 21 for receiving waste water from the waste food collecting unit 30, a lid 1022 allowing access to the interior of the main tank and secured to the exterior of the tank 1020, and an outlet 1026. The main tank 1020 is similarly thermally insulated, with the same heating potential as apparatus 10.

The inlet 1021 is typically a waste water inlet for receiving waste water having scum contaminants. The inlet is typically connected to the food collecting unit 1030, which acts to remove larger particulates from the waste water prior to passing the waste water to the main tank 1020. It can be appreciated that the waste food collecting unit 1030 may be bypassed or omitted such that waste water directly enters the main tank via the inlet 1021.

The lid 1022 allows for easy servicing of the apparatus 1010 by providing access to the housing to check the internal components, fill-level, etc. As with the main tank 1020, the lid 22 is also typically thermally insulated in a similar manner. Lugs 1027 are shown for holding the lid closed, but any suitable closure can be provided. In the illustrated embodiment, the lid comprises four lugs 1027 configured to couple the lid to the main tank. The lugs 1027 are rubber in the illustrated embodiment. It can be appreciated that the lugs 1027 may be used to lock the lid in place to prevent tampering with the contents inside the main tank 1020. The main tank 1020 may comprise a gasket (not pictured) configured to seal the lid 1022 against the main tank 1020. This gasket is configured to interact with the lid 1022, such that a non-airtight seal is formed. This allows air to flow in the tank 1020 and prevents a vacuum being formed, which would inhibit the draining of the contaminants into the waste collection tank 1040. The gasket may interact with ribbing on the underside of the lid 1022.

The outlet 1026 is provided on an external surface of the tank. The outlet allows for treated waste water to leave the unit 1010. Multiple outlets may be provided as needed. The outlet is connected to the sewage or waste water system. It may be directly connected to the sewage system, or it may be coupled using an additional pipe or conduit or the like.

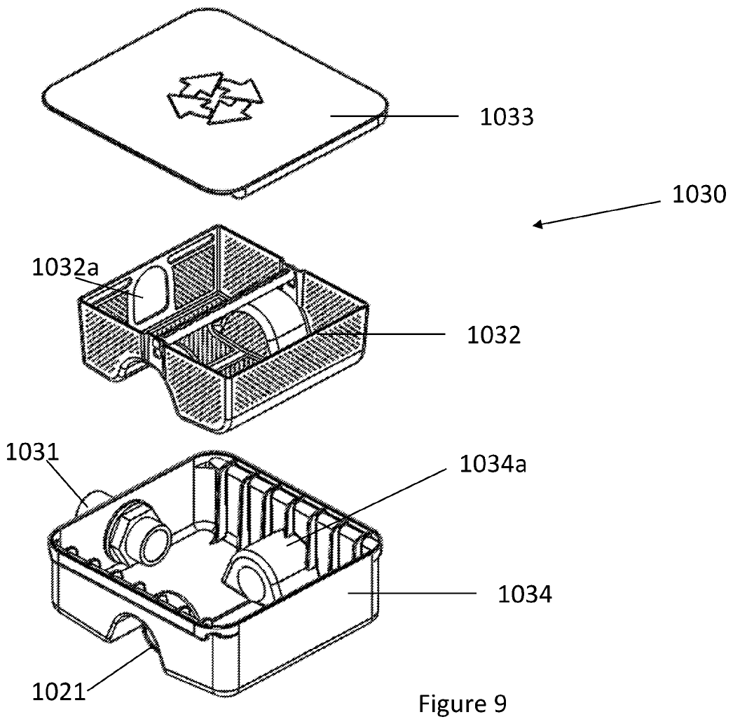

Coupled to the main tank 20 via a fluid coupling 21 is a waste food collecting unit 30, discussed further with reference to FIG. 9.

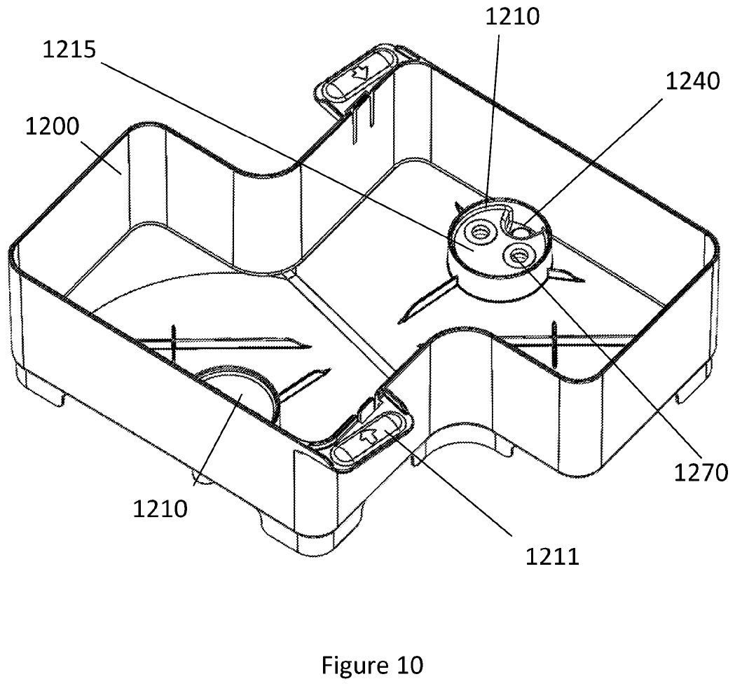

Similar to the tank 20 of FIG. 2, the main tank 1020 further comprises a water collection chamber (not pictured), for collecting the waste water from the inlet 1021. The water collection chamber 122 extends across the base of the main tank 20. The main tank 1020 additionally comprises a grease removal unit 1200 (FIG. 10) for treating the waste water by separating the scum contaminants from the waste water and into the waste collection tank 1040. Main tank 1020 further comprises an additional option for a second inlet 1021a. The second inlet area 1021a allows for an inlet 1021 to be mounted on the opposite side of the main tank 1020. This also allows for the waste food trap 10303 to be mounted on either side. This gives the main tank 1020 a rotational symmetry of 2, which allows it to be mounted reversibly by the end user. Improved flexibility in mounting the main tank 1020 improves the ease of use of the apparatus 1010, and allows for configurations where prior art apparatuses may not fit.

The chamber and wall system described with reference to FIG. 2 applies to the water collection chamber of the illustrated embodiment, where internal walls (not pictured) divide the water collection chamber into several subchambers to divert and direct flow of the waste water.

The waste collection tank 1040 is provided with the main tank 1020. As with FIG. 1, the collection tank 1040 lies substantially flush against a lower portion of the exterior of the main tank 1020. The collection tank 1040 lies against a corresponding indented section of the lower portion.

The apparatus 101 further comprises a base 1050. The base 1050 is configured to support the main tank 1020 and one or more waste collection tanks 1040 placed against the main tank 1020. The base further comprises wheels 1055, providing a mobile apparatus. This further improves the user-friendliness of the apparatus 1010. In the illustrated embodiment, the wheels 1055 are placed at the four corners of the base 1050, which extends across the bottom area of the main tank 1020. The base 1050 comprises lips 1052 which extend beyond the main tank 1020, on which the wheels 1055 are mounted. The lips 1052 are raised, with the wheels contained at least partially within the bounds of the lips such that the height of the apparatus is not extended significantly beyond that of the main tank. The lips 1052 may extend from the sides of the main tank 1020 less than the width of the waste food trap 1030, such that the footprint of the apparatus 1010 is kept to a minimum.

A drain tap 1060 may be placed in the body of the main tank 1020, configured to drain contaminants from the main tank 1020 in instances where the grease removal unit 1200 is not present, or in conjunction with the grease removal unit 1200. The drain tap 1060 may also act as an overflow outlet from the main tank 1020.

FIG. 9 illustrates the waste food trap unit 1030. This unit 1030 comprises an inlet 1031 for receiving waste water from a waste water source, such as the drain of a restaurant or other commercial business generating waste water. The inlet 1031 typically receives waste water having contaminants, such as particulate contaminants and scum contaminants such as fat, oil and grease. The waste food collecting unit 1030 comprises a basket 1032 configured to be engaged with the unit 1030, the basket 1032 comprising a mesh over which water from the inlet 1031 flows to sieve larger particulates. A collecting unit lid 33 is provided to allow easy access for cleaning. The basket 1032 is shaped to fit snugly into the body 1034 of the food trap unit 1030. The aperture 1032a is configured to receive inlet 1031, and in combination with the raised archways 1034a in the body which interact with corresponding recesses in the base of the basket 1032, this provides a removable fit in which it is visible that the basket 1032 is placed correctly in the waste food trap unit 1030.

In use, the waste food collecting unit 1030 receives waste water, which passes over the mesh of the basket 1032 to sift non-scum waste contaminants. These are collected in the basket 1032, which can be removed from the body 1034 of the collecting unit. After passing across the mesh, the sieved waste water collects within the unit 1030 and enters the main tank through the inlet 1021. As can be seen from FIG. 9, the waste food trap unit 1030 comprises two apertures that could act as an inlet 1021 into the waste tank. This allows the waste food trap unit 1030 to be mounted on either side of the main tank 1020, as discussed previously.

FIG. 10 illustrates the grease removal unit 1200. The grease removal unit 1200 is placed within the housing such that it sits below the level of the outlet. The grease removal unit comprises a moulded plastic or metal inlet and is configured to engage with the walls of the main tank 1020 and to either form the first and second chambers or to abut against walls that form said chambers. The grease removal unit 1200 comprises protrusions 1211 to engage with corresponding apertures in the walls of the main tank 1020. These protrusions 1211 may comprise an undercut, such that the grease removal unit 1211 can be removed from the main tank 1020 on application of pressure to the protrusions 1211. The engagement mechanism of the protrusions 1211 and corresponding apertures (not pictured) act to prevent the grease removal unit 1200 floating when waste water flows into the main tank 1020.

The grease removal unit 1200 comprises a valve unit 1210 disposed in the base of the grease removal unit 1200 and opens to draw scum from the surface of the waste water within the main tank 1020.

The valve unit 1210 is configured to direct the scum into the waste collection tank 1040. In the illustrated embodiment, two valve units 1210 are present, disposed opposite one another such that the grease removal unit 1200 has a rotational symmetry of two, allowing it to be mounted in two orientations within the main tank 1020. The multiple valve units 1210 each have a separate waste collection tank fitting, although it is envisaged that a common waste collection tank may be used if appropriate.

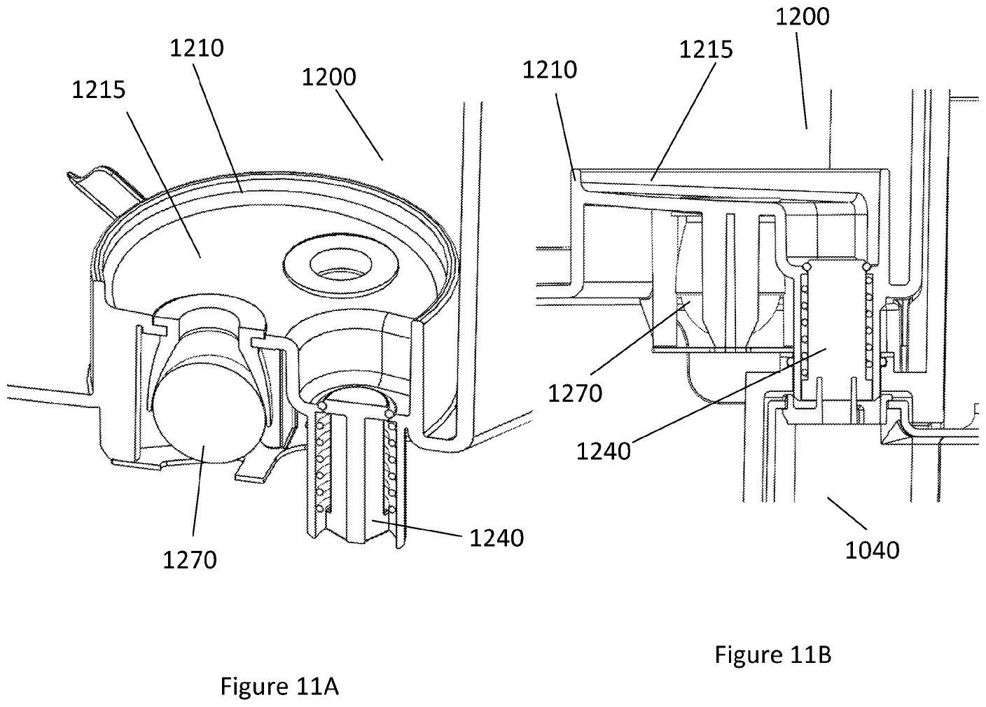

FIGS. 11A and 11B show the valve unit 1210 in greater detail. The valve unit 1210 comprises two inlet valves 1270 that are configured to open to admit scum from the surface of the waste water in the main tank 1020 and onto a runoff surface 1215 of the valve unit 210. The runoff surface 1215 is angled such that fluid flows from the water collection chamber to the waste collection tank 1040. Accordingly, as the valves 1270 of the grease removal unit 1200 open to the water collection chamber to collect scum contaminants from the surface of the waste water, the contaminants are syphoned from the waste water and run onto the runoff surface 1215 towards the waste collection tank 1040 due to the angle of the runoff surface 1215.

Although shown with two inlet valves 1270, it can be appreciated that one valve, or more than two valves may be used. The inlet valves 1270 allow the scum contaminants in the waste water within the water collection chamber to be controllably removed by the valve and collected into the waste collection tank 1040. The illustrated inlet valves 1270 are ball valves. used to isolate and fluidly communicate the grease removal unit 1200 with the water collection chamber of the main tank 1020 such that as the ball valve 1270 opens it allows scum contaminants (fats, grease and the like) to enter the grease removal unit 1200 and flow along the runoff surface 1215. The ball valve 1270 may be an automatic ball valve such that the grease removal unit 1200 is isolated or coupled to the water collection chamber as needed. For example, the grease removal unit 1200 may be isolated when replacing the waste collection tank 1040, or when the waste collection tank 1040 is full.

The valve unit 1210 further comprises an isolation valve 1240. The isolation valve is disposed between the waste collection tank 1040 and the grease removal unit 1200, and configured to admit the contaminants from the grease removal unit 1200 into the waste collection tank 1040. The isolation valve is opened by insertion of a water collection tank 40 into engagement with the main tank 20. The waste collection tank 1040 engages with the isolation valve 1240, and acts as an actuator, engaging with the stem of the isolation valve 1240 and opening the isolation valve 1240. Accordingly, when the isolation valve 1240 engages with the waste collection tank, the waste collection tank 1040 and the grease removal unit 1200 are fluidly coupled and the isolation valve 1240 is generally held in the open position when the waste collection tank 1040 is engaged. On removal of the waste collection tank 1040, the isolation valve 1240 will close, prevent contaminants from exiting the grease removal unit 1200 without a waste collection tank 1040 present.

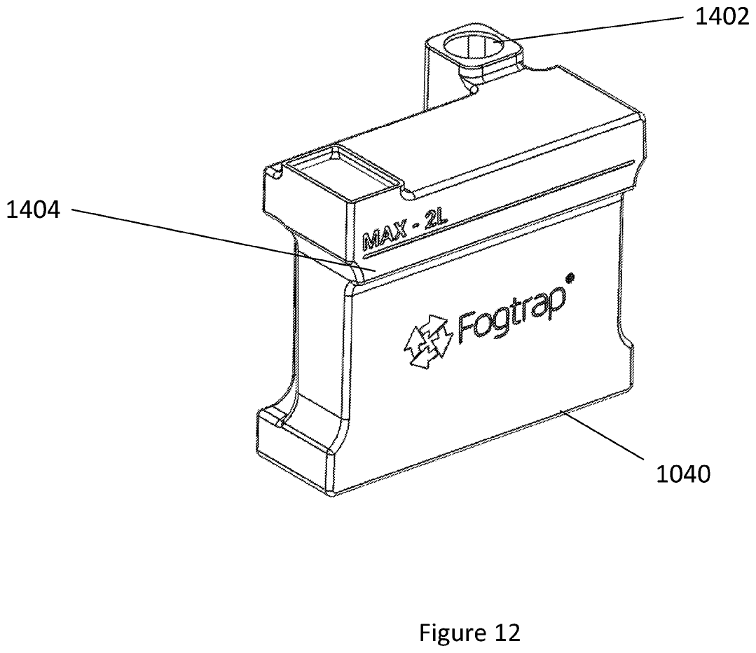

The waste collection tank 1040 is shown in FIG. 12. As described above, the tank 40 is configured to engage with the main tank. The waste collection tank 1040 comprises an inlet 1402. The shape of the waste collection tank as shown allows for easy alignment of the inlet 1402 with the isolation valve 12400 to provide easy engagement with the actuator.

The waste collection tank comprises an indicator 1404 to show the current fill level of waste contaminants within the tank. The indicator 1404 shows a level of contaminants collected by the waste collection tank to allow determination of when to replace or empty the tank. The indicator may include a visual limit indicator, or a timing unit or the like that indicates when the waste collection tank should be replaced or emptied. The indicator acts as a visual alert to alert a user that the waste collection tank 1040 should be replaced or emptied.

From reading the present disclosure, other variations and modifications will be apparent to the skilled person. Such variations and modifications may involve equivalent and other features which are already known in the art of the grease removal units, and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The applicant hereby gives notice that new claims may be formulated to such features and/or combinations of such features during the prosecution of the present application or of any further application derived therefrom.

For the sake of completeness it is also stated that the term “comprising” does not exclude other elements or steps, the term “a” or “an” does not exclude a plurality, and reference signs in the claims shall not be construed as limiting the scope of the claims.

1-29. (canceled)

30. An apparatus suitable for treating waste water to remove scum contaminants such as fat, oil, and grease, said apparatus comprising:
a main tank, said main tank comprising:
an inlet for receiving the waste water from a waste water source; and
a water collection chamber, for collecting the waste water from the inlet;
a drain tap configured to engage with the body of the main tank and configured to drain scum contaminants from the main tank;
wherein the main tank is thermally insulated.

31. The apparatus of claim 30, further comprising:
a grease removal unit for treating the waste water by separating the scum contaminants from the waste water; and
a waste collection tank in fluid communication with the grease removal unit for collecting the contaminants, wherein the waste collection tank is removably coupled to the main tank.

32. The apparatus of claim 31, wherein the grease removal unit comprises a valve, said valve in fluid communication with the water collection chamber and with the waste collection tank.

33. The apparatus of claim 32, wherein the valve is configured to open to selectively collect the scum contaminants from the surface of the waste water within the water collection chamber and to close to isolate the water collection surface from the valve.

34. The apparatus of claim 33, wherein the valve is configured to open to drain the scum contaminants into the waste collection tank and to close to isolate the waste collection tank from the grease removal unit.

35. The apparatus of claim 34, wherein the grease removal unit comprises a runoff surface, said surface angled such that fluid flows from the water collection chamber to the waste collection tank via the grease removal unit.

36. The apparatus of claim 30, wherein the main tank further comprises an inlet chamber in fluid communication with the inlet, said inlet chamber comprising an angled surface to induce vortex currents in the waste water to slow movement of the waste water.

37. The apparatus of claim 30, wherein the main tank further comprises an outlet for removing treated waste water from the main tank.

38. The apparatus of claim 37, wherein the grease removal unit is positioned above the water collection chamber, and is fluidly isolated from the inlet and from the outlet.

39. The apparatus of claim 38, wherein the grease removal unit is a baffle between the top of the main tank and the water collection chamber.

40. The apparatus of claim 30, wherein the apparatus further comprises a waste food collecting unit coupled to the inlet, said waste food collecting unit configured to remove debris from the waste water prior to entry into the inlet.

41. The apparatus of claim 31, wherein the waste collection tank is coupled to the main tank by a retaining knob, said knob engaging through the waste collection tank to a housing of the main tank.

42. The apparatus of claim 41, wherein the retaining knob comprises a bayonet locking mechanism to retain the waste collection tank.

43. The apparatus of claim 31, wherein the waste collection tank comprises an indicator to indicate to a user that the waste collection tank should be replaced or emptied.

44. The apparatus of claim 30, further comprising:
a lid configured to cover the main tank, wherein a gasket is provided between the lid and the main tank, such that the seal is not airtight.

45. The apparatus of claim 44, wherein the lid comprises a plurality of lug latches to secure the lid to the main tank, such that the lid has no hinge point.

46. The apparatus of claim 31, wherein:
the main tank comprises two inlets and has a rotational symmetry of 2, such that it can be mounted reversibly.

47. The apparatus of claim 32, wherein the grease removal unit comprises a pair of valves, wherein the second valve is disposed opposite the first valve such that the grease removal unit has a rotational symmetry of 2 and can be mounted reversibly within the main tank.

48. The apparatus of claim 31, further comprising:
a base configured to support the main tank and the one or more waste collection tanks.

49. The apparatus of claim 48, wherein the base comprises wheels to aid transport of the apparatus.
